(19) United States
(12) Patent Application Publication
(10) Pub. No.: US 2024/0127303 A1
(43) Pub. Date: Apr. 18, 2024

(54) REPORTING SYSTEM, METHOD, AND RECORDING MEDIUM

(71) Applicant: NEC Corporation, Minato-ku, Tokyo (JP)

(72) Inventor: Yuki Tsuruoka, Tokyo (JP)

(73) Assignee: NEC Corporation, Minato-ku, Tokyo (JP)

(21) Appl. No.: 18/275,748

(22) PCT Filed: Sep. 29, 2021
(86) PCT No.: PCT/JP2021/035769

§ 371 Date: Aug. 3, 2023

(51) Int. Cl. G06Q 30/0601

(52) U.S. Cl. CPC G06Q 30/0607

(57) ABSTRACT

A reporting system according to an aspect of the present disclosure includes: at least one memory configured to store instructions; and at least one processor configured to execute the instructions to: acquire a customer image obtained by capturing an image of a customer in a shop; estimate an age of the customer from the customer image; detect an action related to retrieval of an age-restricted product displayed in the shop; and report retrieval of the age-restricted product by the customer based on an estimated age of the customer and a result of the detection.

### TECHNICAL FIELD

The present disclosure relates to a reporting system and the like.

### BACKGROUND ART

In convenience stores, some products, such as cigarettes, for which purchase is restricted by age, are stored in racks near cash registers where customers cannot reach in order to prevent shoplifting. The customer tells the clerk about the product that the customer wishes to purchase, and causes the clerk to take the product from the rack. The clerk determines whether the customer satisfies the age requirement, and sells the product.

As a technique related to the present disclosure, PTL 1 discloses a checkout device that analyzes an image obtained by taking an image of a customer and determines whether an age requirement is satisfied when identification information of an age-restricted product is input.

### CITATION LIST

### Patent Literature

PTL 1: JP 2016-181013 A

### SUMMARY OF INVENTION

Technical Problem

If the customer can take the product from the fixture, it is possible to reduce the work burden on the clerk who takes the product for the customer. However, if the customer can freely retrieve an age-restricted product from the fixture, even a customer with an age at which purchase is restricted may be able to retrieve the product. It is also burdensome for the clerk to perform monitoring to prevent a customer with an age at which purchase is restricted from retrieving the product. PTL 1 does not refer to managing a product displayed on a fixture.

An object of the present disclosure is to provide a reporting system and the like for managing an age-restricted product displayed on a fixture.

### Solution to Problem

A reporting system according to the present disclosure includes an image acquisition means that acquires a customer image obtained by capturing an image of a customer in a shop, an age estimation means that estimates an age of the customer from the customer image, a detection means that detects an action related to retrieval of an age-restricted product displayed on a fixture installed in the shop, and a reporting means that reports retrieval of the age-restricted product by the customer based on an estimated age of the customer and a result of the detection.

A method according to the present disclosure includes acquiring a customer image obtained by capturing an image of a customer in a shop, estimating an age of the customer from the customer image, detecting an action related to retrieval of an age-restricted product displayed on a fixture installed in the shop, and reporting retrieval of the age-restricted product by the customer based on an estimated age of the customer and a result of the detection.

A program according to the present disclosure causes a computer to execute acquiring a customer image obtained by capturing an image of a customer in a shop, estimating an age of the customer from the customer image, detecting an action related to retrieval of an age-restricted product displayed on a fixture installed in the shop, and reporting retrieval of the age-restricted product by the customer based on an estimated age of the customer and a result of the detection.

### Advantageous Effects of Invention

According to the present disclosure, an age-restricted product displayed on a fixture can be managed.

### BRIEF DESCRIPTION OF DRAWINGS

FIG. 1 is a block diagram illustrating a configuration example of a reporting system 100.

FIG. 2 is a flowchart illustrating an operation example of the reporting system 100.

FIG. 3 is a schematic diagram illustrating an example of a fixture for displaying age-restricted products.

FIG. 4 is a block diagram illustrating another configuration example of the reporting system 100.

FIG. 5 is a display example of information regarding retrieval of age-restricted products.

FIG. 6 is a block diagram illustrating an example of a hardware configuration of a computer 500.

### EXAMPLE EMBODIMENT

Example embodiments of an information processing system, an information processing method, a program, and a non-transitory recording medium recording the program according to the present disclosure will be described in detail with reference to the drawings. The example embodiments do not limit the disclosed technology.

### First Example Embodiment

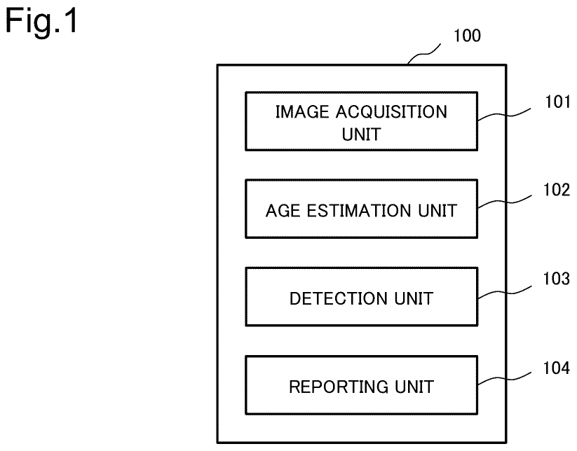

FIG. 1 is a block diagram illustrating a configuration example of a reporting system 100 according to one example embodiment. The reporting system 100 includes an image acquisition unit 101, an age estimation unit 102, a detection unit 103, and a reporting unit 104.

The reporting system 100 according to one example embodiment is used to report that a customer in a shop has retrieved an age-restricted product from a fixture for displaying the age-restricted product. The age-restricted product has, for example, the lower limit of the age at which the product can be purchased. The product provided with the lower limit is, for example, tobacco or alcohol. Note that the age-restricted product may be a product for which the upper limit of the age at which the product can be purchased is set.

The image acquisition unit 101 acquires a customer image obtained by capturing an image of a customer in a shop. The customer image may be a facial image including the face of the customer. In addition, the customer image may be a body image including the body of the customer.

The customer image is taken by a camera that takes an image of a customer in front of a fixture displaying an age-restricted product. For example, the camera may be installed on the fixture or near the fixture. However, the installation place of the camera is not limited thereto. The image acquisition unit 101 may acquire the customer image from a monitoring camera generally installed in a shop.

The age estimation unit 102 estimates the age of the customer from the customer image acquired by the image acquisition unit 101. Any method including a known method is used as the estimation method. For example, the age estimation unit 102 may estimate the age of the customer from the facial image based on the relationship between the face feature and the age. In addition, the age estimation unit 102 may estimate the age of the customer based on the height, body shape, or gait of the customer estimated from the body image.

The age estimation unit 102 may estimate the age group of the customer. In addition, the age estimation unit 102 may estimate whether or not the customer satisfies a predetermined age requirement. For example, the age estimation unit 102 may estimate whether the customer is 20 years old or older. The age estimation unit 102 may estimate whether the customer is under 20 years old or a minor.

The detection unit 103 detects an action related to the retrieval of the age-restricted product displayed on the fixture installed in the shop. The detection unit 103 detects, for example, the movement of the customer or the movement of the age-restricted product, thereby detecting an action related to retrieval. The action related to the retrieval of the age-restricted product may include, for example, an action of lifting the product, an action of putting a hand into the fixture, an action of opening the door of the fixture, and an action of closing the door. Any method including a known method is used as the action detection method.

For example, the detection unit 103 may detect the action based on the customer image acquired by the image acquisition unit 101. Here, the image acquisition unit 101 acquires the customer image from a camera that captures the image of the posture of the customer around the fixture. The detection unit 103 may detect the action by estimating the position of the hand or the posture of the customer including the orientation of the body from the customer image.

Alternatively, the detection unit 103 may detect an action of retrieving the product based on an image obtained by capturing the image of the interior of the fixture. The detection unit 103 may detect that there is an action of retrieving the product when the product on the fixture disappears.

Further, the detection unit 103 may detect an action related to the retrieval of the product based on an output of a sensor or detecting a movement of an object. When the hand of the customer is present or the product is retrieved, the output of the sensor changes. The sensor for detecting a movement of an object includes, for example, an infrared sensor, a human sensor, or a distance-measuring sensor. For example, the distance-measuring sensor measures a distance from the position of the sensor to an object at the position of the opening of the fixture. The distance-measuring sensor is, for example, a light detection and ranging (LiDAR) scanner. The detection unit 103 may detect the action related to the retrieval of the product based on a change in the output of the sensor.

In addition, the detection unit 103 may detect an action of opening or closing a door based on an output of a door opening/closing sensor provided in the fixture. The detection unit 103 may detect an action of lifting up the product based on an output of a pressure sensor provided in the fixture. The pressure sensor detects pressure received from a displayed product.

The reporting unit 104 reports the retrieval of the age-restricted product by the customer whose age has been estimated based on the estimated age of the customer and the detection result. The reporting unit 104 acquires the detection result of the action related to the retrieval of the age-restricted product from the detection unit 103. Moreover, the reporting unit 104 acquires the estimated age of the customer who has retrieved the product from the age estimation unit 102. For example, the reporting unit 104 acquires an estimated age of a person in front of the fixture when the action of retrieving the product is detected.

The reporting unit 104 reports that a customer having an estimated age that satisfies a predetermined condition retrieves the age-restricted product. The predetermined condition is, for example, that the estimated age of the customer is outside a purchase target age. For example, the reporting unit 104 reports that a customer estimated to be outside the product purchase target age. When a customer having an estimated age that does not satisfy the predetermined condition retrieves the age-restricted product, the reporting unit 104 may not perform reporting. Note that the predetermined condition may include that the estimated age is close to a threshold of the age of the purchase target. For example, even when the purchase target age is satisfied, the reporting unit 104 may report the retrieval when the estimated age is close to the threshold.

For example, the reporting unit 104 may report a customer estimated to be a minor and may not report a customer estimated to be an adult. The reporting unit 104 may also perform reporting when it is not certain whether the customer is a minor or an adult, for example, when the customer is estimated to be between 20 and 29 years old.

The reporting unit 104 causes an arbitrary reporting device to report the retrieval. The reporting device is, for example, a loudspeaker, a lamp, or a display. The loudspeaker plays a voice or notification sound at the direction of the reporting unit 104. The reporting unit 104 may perform reporting by turning on a lamp. The display shows a reporting message such as “A product requiring age verification has been retrieved” at the direction of the reporting unit 104. The reporting unit 104 may perform reporting by a plurality of reporting devices.

The reporting unit 104 may report to the customer who has retrieved the product or other customers in the shop, or may report to the clerk. The customer who receives the report becomes aware that the retrieval of the product is managed. The clerk who has received the report may go to the location of the customer who retrieved the product and verify the age of the customer. Alternatively, the clerk who has received the report may confirm that the customer has retrieved the product after the customer has left the shop. The reporting device may be provided around the fixture or mounted on the fixture. The reporting device may be a terminal used by a clerk, including a shop register and a terminal carried by the clerk. Note that the reporting device may be a terminal used by a customer.

The reporting unit 104 may specify that the customer whose age has been estimated and the customer who has retrieved the product are the same person based on the customer image. The reporting unit 104 may specify that the customer whose age has been estimated and the customer who has retrieved the product are the same person based on the time when the action is detected and the time when the image of the customer is taken in front of the fixture.

The reporting unit 104 may provide different reports according to the estimated age of the customer. For example, the reporting unit 104 may change the reporting level depending on whether or not the customer is at the purchase target age for the product. In addition, the reporting unit 104 may change the reporting level depending on the age group. The reporting level includes, for example, a warning and a normal report.

For example, when the customer is a minor, the reporting unit 104 causes the loudspeaker to play a warning sound as a warning, and when the customer is an adult, the reporting unit 104 causes the loudspeaker to play music or a notification sound as a normal report. The warning sound may have a larger volume or a longer playback time than the notification sound. The reporting unit 104 may turn on a red lamp in the case of warning, and may turn on a green lamp as a normal report. The reporting unit 104 may cause a notification sentence to be shown on the display as a report, a red or yellow color to be shown on the display as a warning, and the shown color to blink.

The reporting system 100 may be implemented by a shop server, a shop register, or the like. In addition, the reporting system 100 may be implemented by a terminal mounted on a fixture for displaying a product.

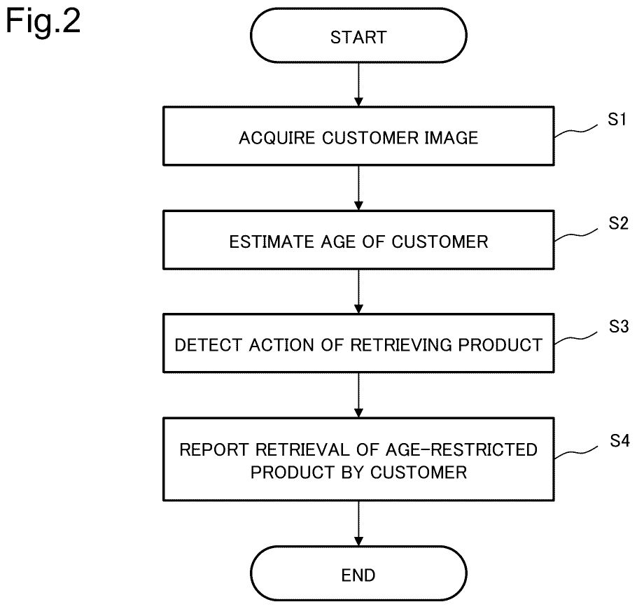

FIG. 2 is a flowchart illustrating an operation example of the reporting system 100. For example, when a person is detected in front of the camera, the reporting system 100 may start the operation of FIG. 2. The image acquisition unit 101 of the reporting system 100 may activate the camera based on detection of a person in front of the camera. For example, the image acquisition unit 101 may start the camera based on detection of a person staying in front of the camera for a predetermined time or more. Alternatively, the image acquisition unit 101 may activate the camera even when a person passes in front of the camera.

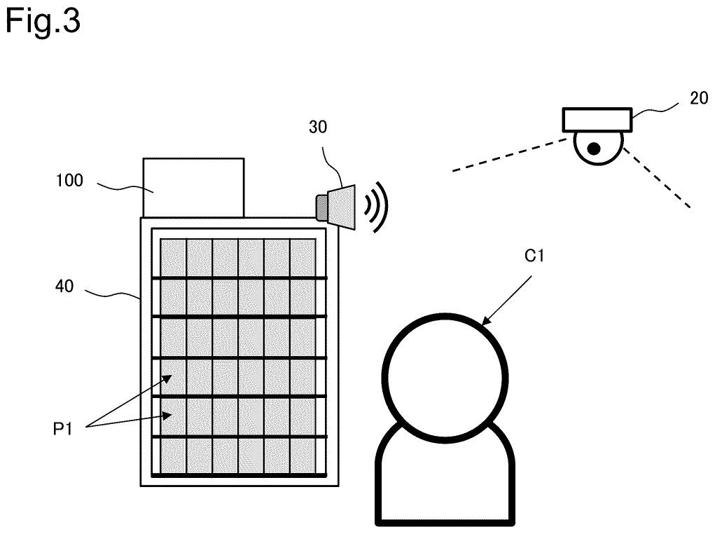

FIG. 3 is a schematic diagram illustrating an example of a fixture installed in a shop and displaying age-restricted products. In FIG. 3, age-restricted products P1 are displayed on a fixture 40. A customer C1 retrieves an age-restricted product P1 from the fixture 40. The reporting system 100 and a loudspeaker 30 are mounted on the fixture 40. Note that the reporting system 100 may be installed in backrooms of the shop or the like. Further, a camera 20 is installed on the ceiling. Note that the camera 20 may be mounted on the fixture 40. The camera 20 captures the image of the customer C1 retrieving an age-restricted product P1. The camera 20 and the loudspeaker 30 are communicably connected to the reporting system 100 in a wired or wireless manner.

For example, the image acquisition unit 101 acquires, from the camera 20, a customer image obtained by capturing an image of a customer in front of the fixture 40 (step S1). The image acquisition unit 101 transmits the customer image to the age estimation unit 102. The image acquisition unit 101 may further transmit the customer image to the detection unit 103.

The age estimation unit 102 estimates the age of the customer from the customer image (step S2).

The detection unit 103 detects an action related to the retrieval of the product (step S3). The detection unit 103 detects the action of the customer based on, for example, an output of at least one of a door opening/closing sensor of the fixture, a retrieval sensor provided in the fixture, and a camera that captures an image of a posture of the customer around the fixture. The detection unit 103 may detect the action based on the customer image taken by the camera 20.

Step S3 may be performed before step S2 or before step S1.

The reporting unit 104 reports the customer about the retrieval of the age-restricted product based on the estimated age of the customer and the detection result of the action (step S4). For example, when the customer C1 having an estimated age that satisfies the predetermined condition retrieves the age-restricted product, the reporting unit 104 causes the loudspeaker 30 to play a reporting sound.

In one example embodiment, the image acquisition unit 101 acquires a customer image obtained by capturing an image of a customer in a shop. The age estimation unit 102 estimates the age of the customer from the customer image. Then, the detection unit 103 detects an action related to retrieval of an age-restricted product displayed on a fixture installed in the shop. The reporting unit 104 detects the retrieval of the age-restricted product by the customer based on the estimated age of the customer and the detection result of the action. Therefore, according to the reporting system 100, the age-restricted product displayed on the fixture can be managed.

According to the reporting system 100, the reporting unit 104 performs reporting, thus enabling reduction in the labor of a clerk who manages the age-restricted product. Moreover, there is no need to provide a lock, a door, a customer authentication system, and the like on the fixture, thus enabling prevention of cost increases for the fixture. Furthermore, according to the reporting system 100, there is no need for the customer to pre-register personal information in order to retrieve the product from the fixture, which is convenient for the customer.

Cigarettes are highly prone to shoplifting due to having a small size. In addition, it is not preferable for a minor to be able to freely retrieve cigarettes. Therefore, the reporting system 100 can be used, for example, to manage cigarettes.

The reporting system 100 can be used in both an unattended shop and a manned shop. The unattended shop is a shop where a customer can purchase a product without a clerk. For example, a customer retrieves a product from a fixture and pays for the product. The checkout may be performed through a clerk or by the customer himself/herself. The age of the customer may be verified at checkout.

### Second Example Embodiment

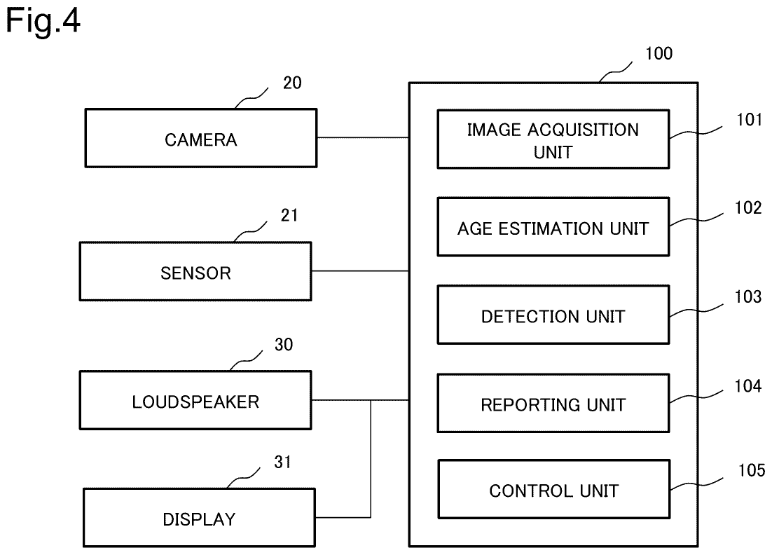

FIG. 4 is a block diagram illustrating a configuration example of a reporting system 100 according to another example embodiment. The reporting system 100 according to the second example embodiment is different from the reporting system 100 according to the first example embodiment in including the control unit 105. A detailed description of the configurations of an image acquisition unit 101, an age estimation unit 102, a detection unit 103, and a reporting unit 104 according to the second example embodiment, similar to those of the first example embodiment, will be omitted.

Devices including a camera 20, a sensor 21, a loudspeaker 30, and a display 31 may be connected to the reporting system 100. However, some of these devices may not be connected to the reporting system 100, and devices other than these devices may be connected thereto.

The camera 20 takes a customer image and transmits the image to the image acquisition unit 101. The number of cameras 20 is not limited to one, and a plurality of cameras 20 may be connected to the reporting system 100.

The sensor 21 transmits a signal to the detection unit 103. The detection unit 103 detects an action related to retrieval of a product based on the sensor signal. The sensor 21 is, for example, a pressure sensor, a door opening/closing sensor, or a camera. When the image acquisition unit 101 and the detection unit 103 use the same customer image, the camera 20 and the sensor 21 may be a single camera.

The reporting unit 104 reports that an age-restricted product has been retrieved using the loudspeaker 30 and the display 31.

The control unit 105 causes a storage unit (not illustrated) to store information regarding the retrieval of the age-restricted product by the customer. The control unit 105 may store information every time retrieval is detected. The control unit 105 may further store in the storage unit an image obtained by continuously taking the image of the inside of the shop. When there is a retrieval, the control unit 105 may store information regarding the retrieval in association with the image obtained by continuously taking the image of the inside of the shop. However, the mode of storage is not particularly limited. The stored information is used by the clerk to confirm the situation when the product was retrieved.

The information regarding the retrieval includes at least one of the time when the age-restricted product was retrieved, information regarding the customer retrieving the age-restricted product, and information regarding the retrieved product.

The time at which the age-restricted product was retrieved is, for example, a time at which the detection unit 103 detected an action of retrieving the product. By storing the time, the clerk can confirm the situation by reviewing the video of the monitoring camera at the same time or in the same time zone.

The information regarding the customer includes, for example, an image of the customer or an estimated age. The control unit 105 may store the customer image acquired by the image acquisition unit 101 or the estimated age estimated by age estimation unit 102. When the age estimation unit 102 further estimates the gender of the customer, the information regarding the customer may include the gender of the customer.

The information regarding the product retrieved includes, for example, a product name or a display position of the product retrieved. The clerk can specify the retrieved product using the product name or the display position. The detection unit 103 may specify the retrieved product based on a sensor signal. The detection unit 103 may specify the product name with reference to a database storing the feature amount of the product image or a database storing the position of the product. Further, the detection unit 103 may specify the display position of the retrieved product based on a sensor signal. The display position of the retrieved product is also called an acquisition position because it indicates where the customer has retrieved the product from. The acquisition position is specified as, for example, the upper left side, the middle right side, or other locations of the fixture.

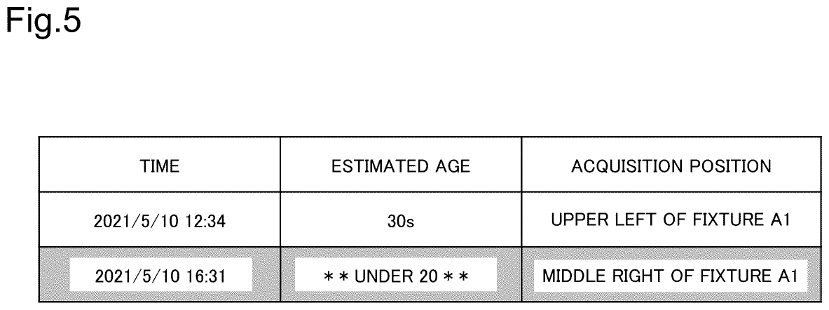

The reporting unit 104 may perform reporting based on the information stored by the control unit 105. For example, the reporting unit 104 causes the display 31 to show information regarding the retrieval of the age-restricted product by customers. The reporting unit 104 may cause the list illustrated in FIG. 5 to be shown on the display 31. FIG. 5 is a display example of the information regarding the retrieval of the age-restricted product by customers.

The list in FIG. 5 includes the time when the age-restricted product was retrieved, the estimated age of the customer, and the acquisition position of the product. The reporting unit 104 may make the information stand out depending on whether or not the estimated age satisfies a predetermined condition. For example, the reporting unit 104 may display information regarding a customer estimated to be under 20 years old in a different color. In addition, the reporting unit 104 may display a mark near the information of the customer estimated to be under 20 years old.

The reporting unit 104 may display an image corresponding to the retrieval based on the selection of the information regarding the extraction. The image corresponding to the retrieval is, for example, an image of the customer retrieving the product, an image in the fixture or the shop at the time when the product was retrieved, or a customer image used for age estimation. For example, in FIG. 5, when the clerk clicks a row in the list, the reporting unit 104 causes the display 31 to show an image corresponding to the clicked row.

The control unit 105 may store information regarding the retrieval of the product for a customer having an estimated age that satisfies the predetermined condition. When the information of the customer satisfying the predetermined condition is stored, the clerk can check the record more easily than when the information of the retrieval by all customers is stored. For example, the control unit 105 may store only information regarding the retrieval of the product by a customer estimated to be a minor.

In the second example embodiment, the control unit 105 causes the information regarding the retrieval of the age-restricted product by the customer to be stored. Then, the reporting unit 104 displays the information regarding retrieval. Therefore, the clerk can confirm the situation when the product was retrieved.

The clerk may confirm the stored information when the number of products in stock on the record does not match the number of products displayed. For example, the clerk may check what kind of person was in front of the fixture when the product ran out.

### [Modification]

The reporting system 100 according to each example embodiment can be modified as follows, for example.

The detection unit 103 may start detecting the action of retrieving the product in response to an estimation that the age of the customer satisfies the predetermined condition. For example, the detection unit 103 may detect the retrieval of the product only when it is estimated that the customer is a minor.

The age estimation unit 102 may start the estimation of the age in response to the detection of the action of retrieving the product. For example, the age estimation unit 102 estimates the age of the customer, after receiving the detection result from the detection unit 103. The image acquisition unit 101 may acquire the customer image after receiving the detection result from the detection unit 103. The image acquisition unit 101 may activate the camera based on the detection result.

The reporting system 100 may start acquiring an image according to a direction from a customer. For example, the customer may operate a touch panel display installed on or near the fixtures and give the reporting system 100 a direction to start acquiring an image. The image acquisition unit 101 activates the camera based on the input from the touch panel, and acquires the customer image. The touch panel may be an example of a reporting device for the reporting unit 104 perform reporting.

The reporting system 100 may further include a display control unit. A display control unit according to the modification causes a display around the fixture to show an image obtained by capturing an image of a customer around the fixture. The display may be an example of a reporting device for the reporting unit 104 to perform a report. The image obtained by capturing the image of the customer around the fixture is, for example, the customer image described above.

By the display control unit causing the image of the customer around the fixture to be shown on the display, the customer can recognize that his or her image is being taken. This can make it possible to prevent shoplifting of the product displayed on the fixture.

Further, the image acquisition unit 101 may acquire, for example, a customer image taken by a camera installed at the entrance of the shop or a camera installed at an arbitrary place in the shop. For example, the customer taken in the image is tracked by a camera from the point at which the image was taken to the fixture. Based on the result of the tracking, the reporting unit 104 may specify that the customer whose age has been estimated and the customer who has retrieved the product are the same person.

### [Hardware Configuration]

In the example embodiments described above, each component of the reporting system 100 indicates a block of a functional unit. Some or all of the components of each reporting system 100 may be implemented by any combination of a computer 500 and a program.

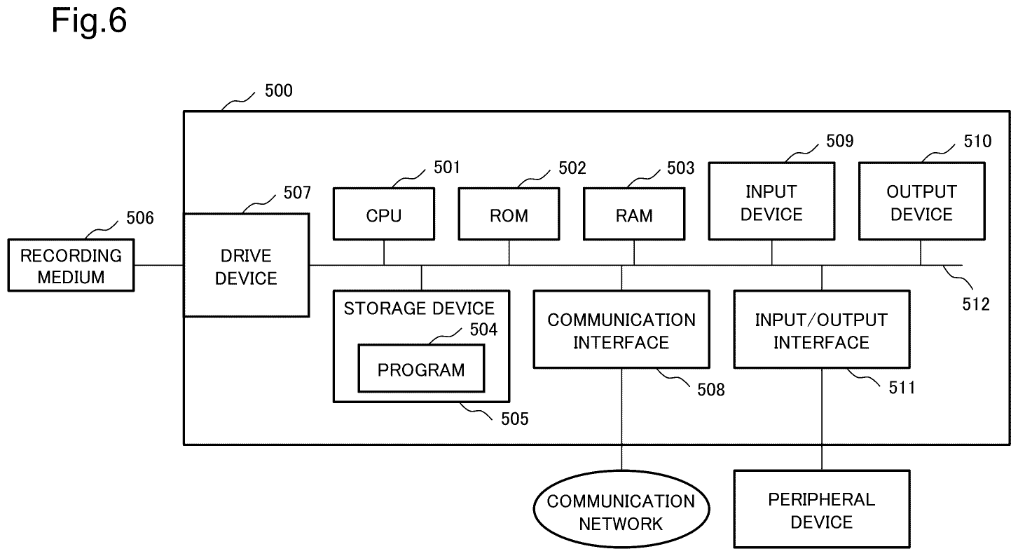

FIG. 6 is a block diagram illustrating an example of a hardware configuration of the computer 500. Referring to FIG. 6, the computer 500 includes, for example, a central processing unit (CPU) 501, a read-only memory (ROM) 502, a random access memory (RAM) 503, a program 504, a storage device 505, a drive device 507, a communication interface 508, an input device 509, an input/output interface 511, and a bus 512.

The program 504 includes instructions for implementing the functions of the respective devices. The program 504 is stored in advance in the ROM 502, the RAM 503, and the storage device 505. The CPU 501 executes the instructions included in the program 504 to implement the function of the respective devices. For example, the CPU 501 of the reporting system 100 executes the instructions included in the program 504 to implement the function of the reporting system 100. Further, the RAM 503 may store data to be processed in the functions of the respective devices. For example, the customer image may be stored in the RAM 503 of the computer 500.

The drive device 507 reads and writes a recording medium 506. The communication interface 508 provides an interface with a communication network. The input device 509 is, for example, a mouse, a keyboard, or the like, and receives an input of information from a clerk or the like. The output device 510 is, for example, a display, and outputs (shows) information to a customer, a clerk, or the like. The input/output interface 511 provides an interface with a peripheral device. The bus 512 connects each component of the hardware. Note that the program 504 may be supplied to the CPU 501 via the communication network, or may be stored in the recording medium 506 in advance, read by the drive device 507, and supplied to the CPU 501. Note that the hardware configuration illustrated in FIG. 6 is an example, and other components may be added, or some components may not be included.

There are various modifications of the method for implementing each device. For example, each device may be implemented by any combination of a computer and a program different for each component. In addition, a plurality of components included in each device may be implemented by any combination of one computer and a program.

Some or all of the components of each device may be implemented by general-purpose or dedicated circuitry including a processor or the like, or the combination of the circuitry. The circuitry may be formed of a single chip or may be formed of a plurality of chips connected via a bus. Some or all of the components of each device may be implemented by a combination of the circuitry described above or the like and a program.

When some or all of the components of each device are implemented by a plurality of computers, circuits, and the like, the plurality of computers, circuits, and the like may be arranged in a centralized manner or in a distributed manner.

At least a part of the reporting system 100 may be provided in a software as a service (SaaS) format. That is, at least some of the functions for implementing the reporting system 100 may be executed by software that is executed via a network.

While the present disclosure has been described with reference to exemplary embodiments thereof, the present disclosure is not limited to these embodiments. It will be understood by those of ordinary skill in the art that various changes in form and details may be made therein without departing from the spirit and scope of the present disclosure as defined by the claims. In addition, the configurations in the respective embodiments can be combined with each other to the extent that the combination does not depart from the scope of the present disclosure.

Some or all of the above embodiments can be described as, but not limited to, the following additions.

### [Supplementary Note 1]

A reporting system including:
an image acquisition means configured to acquire a customer image obtained by capturing an image of a customer in a shop;
an age estimation means configured to estimate an age of the customer from the customer image;
a detection means configured to detect an action related to retrieval of an age-restricted product displayed in the shop; and
a reporting means configured to report retrieval of the age-restricted product by the customer based on an estimated age of the customer and a result of the detection.

### [Supplementary Note 2]

The reporting system according to Supplementary Note 1, in which the reporting means performs reporting when a customer having an estimated age that satisfies a predetermined condition retrieves an age-restricted product.

### [Supplementary Note 3]

The reporting system according to Supplementary Note 1 or 2, in which
the reporting means performs reporting when a customer estimated to be outside a product purchase target age retrieves an age-restricted product.

### [Supplementary Note 4]

The reporting system according to any one of Supplementary Notes 1 to 3, in which
the reporting means performs different reporting according to an estimated age of a customer.

### [Supplementary Note 5]

The reporting system according to any one of Supplementary Notes 1 to 4, in which
the image acquisition means acquires the customer image obtained by capturing an image of a customer in front of a fixture that displays the age-restricted product.

### [Supplementary Note 6]

The reporting system according to any one of Supplementary Notes 1 to 5, in which
the detection means detects a movement of a customer or a movement of an age-restricted product to detect the action related to retrieval of the age-restricted product.

### [Supplementary Note 7]

The reporting system according to any one of Supplementary Notes 1 to 6, in which
the detection means detects the action of the customer based on an output of at least one of an opening/closing sensor of a door of the fixture that displays an age-restricted product, a retrieval sensor provided in the fixture, and a camera that captures an image of a posture of the customer around the fixture.

### [Supplementary Note 8]

The reporting system according to any one of Supplementary Notes 1 to 7, in which
the reporting means displays information regarding retrieval of the age-restricted product by the customer.

### [Supplementary Note 9]

The reporting system according to Supplementary Note 8, in which
the reporting means displays information regarding retrieval of the age-restricted product, including a time of the retrieval.

### [Supplementary Note 10]

The reporting system according to Supplementary Note 8 or 9, in which
the reporting means displays information regarding retrieval of the age-restricted product, including an image of the customer performing the retrieval.

### [Supplementary Note 11]

The reporting system according to any one of Supplementary Notes 7 to 10, in which
the reporting means displays information regarding retrieval of the age-restricted product, including an estimated age of the customer who has performed the retrieval.

### [Supplementary Note 12]

The reporting system according to any one of Supplementary Notes 7 to 11, in which
the detection means detects a movement of a product accompanying retrieval of the product, and
the reporting means further displays information regarding the retrieval including information specifying the product retrieved.

### [Supplementary Note 13]

The reporting system according to any one of Supplementary Notes 1 to 12, in which
the reporting means causes a reporting device provided around a fixture that displays an age-restricted product to report retrieval of the product.

### [Supplementary Note 14]

The reporting system according to any one of Supplementary Notes 1 to 13, in which
the reporting means reports a terminal used by a clerk about retrieval of the product.

### [Supplementary Note 15]

A method including:
acquiring a customer image obtained by capturing an image of a customer in a shop;
estimating an age of the customer from the customer image;
detecting an action related to retrieval of an age-restricted product displayed in the shop; and
reporting retrieval of the age-restricted product by the customer based on an estimated age of the customer and a result of the detection.

### [Supplementary Note 16]

A non-transitory recording medium that records a program for causing a computer to execute:
acquiring a customer image obtained by capturing an image of a customer in a shop;
estimating an age of the customer from the customer image;
detecting an action related to retrieval of an age-restricted product displayed in the shop; and
reporting retrieval of the age-restricted product by the customer based on an estimated age of the customer and a result of the detection.

### REFERENCE SIGNS LIST

101 image acquisition unit
102 age estimation unit
103 detection unit
104 reporting unit
105 control unit
20 camera
21 sensor
30 loudspeaker
31 display
40 fixture
C1 customer
P1 age-restricted product

What is claimed is:

1. A reporting system comprising:
at least one memory configured to store instructions; and
at least one processor configured to execute the instructions to:
acquire a customer image obtained by capturing an image of a customer in a shop;
estimate an age of the customer from the customer image;
detect an action related to retrieval of an age-restricted product displayed in the shop; and
report retrieval of the age-restricted product by the customer based on an estimated age of the customer and a result of the detection.

2. The reporting system according to claim 1, wherein the at least one processor is further configured to execute the instructions to:
report the retrieval when a customer having an estimated age that satisfies a predetermined condition retrieves an age-restricted product.

3. The reporting system according to claim 1, wherein the at least one processor is further configured to execute the instructions to:
report the retrieval when a customer estimated to be outside a product purchase target age retrieves an age-restricted product.

4. The reporting system according to claim 1, wherein the at least one processor is further configured to execute the instructions to:
report the retrieval in different manners according to an estimated age of a customer.

5. The reporting system according to claim 1, wherein the at least one processor is further configured to execute the instructions to:
acquire the customer image obtained by capturing an image of a customer in front of a fixture that displays the age-restricted product.

6. The reporting system according to claim 1, wherein the at least one processor is further configured to execute the instructions to:
detect a movement of a customer or a movement of an age-restricted product to detect the action related to the retrieval of the age-restricted product.

7. The reporting system according to claim 1, wherein the at least one processor is further configured to execute the instructions to:
detect the action of the customer based on an output of at least one of an opening/closing sensor of a door of the fixture that displays an age-restricted product, a retrieval sensor provided in the fixture, and a camera that captures an image of a posture of the customer around the fixture.

8. The reporting system according to claim 1, wherein the at least one processor is further configured to execute the instructions to:
display information regarding the retrieval of the age-restricted product by the customer.

9. The reporting system according to claim 8, wherein
information regarding the retrieval of the age-restricted product include a time of the retrieval.

10. The reporting system according to claim 8, wherein
information regarding the retrieval of the age-restricted product include an image of the customer performing the retrieval.

11. The reporting system according to claim 8, wherein
information regarding the retrieval of the age-restricted product include an estimated age of the customer who has performed the retrieval.

12. The reporting system according to claim 8, wherein the at least one processor is further configured to execute the instructions to:
detect a movement of a product accompanying the retrieval of the product, and wherein
information regarding the retrieval include information specifying the product retrieved.

13. The reporting system according to claim 1, wherein the at least one processor is further configured to execute the instructions to:
cause a reporting device provided around a fixture that displays an age-restricted product to report the retrieval of the age-restricted product.

14. The reporting system according to claim 1, wherein the at least one processor is further configured to execute the instructions to:
report a terminal used by a clerk about the retrieval of the age-restricted product.

15. A method comprising:
acquiring a customer image obtained by capturing an image of a customer in a shop;
estimating an age of the customer from the customer image;
detecting an action related to retrieval of an age-restricted product displayed in the shop; and
reporting retrieval of the age-restricted product by the customer based on an estimated age of the customer and a result of the detection.

16. A non-transitory recording medium that records a program for causing a computer to execute:
acquiring a customer image obtained by capturing an image of a customer in a shop;
estimating an age of the customer from the customer image;
detecting an action related to retrieval of an age-restricted product displayed in the shop; and
reporting retrieval of the age-restricted product by the customer based on an estimated age of the customer and a result of the detection.
